(19) United States
(12) Patent Application Publication
(10) Pub. No.: US 2021/0158692 A1
(43) Pub. Date: May 27, 2021

(54) INFORMATION PROCESSING DEVICE, INFORMATION PROCESSING SYSTEM, AND COMPUTER READABLE RECORDING MEDIUM

(71) Applicant: TOYOTA JIDOSHA KABUSHIKI KAISHA, Toyota-shi (JP)

(72) Inventors: Naoki Uenoyama, Nagoya-shi (JP); Shin Sakurada, Toyota-shi (JP); Kazuya Nishimura, Anjo-shi (JP); Hikaru Gotoh, Nagoya-shi (JP); Hirofumi Kamimaru, Fukuoka-shi (JP)

(73) Assignee: TOYOTA JIDOSHA KABUSHIKI KAISHA, Toyota-shi (JP)

(21) Appl. No.: 17/104,461

(22) Filed: Nov. 25, 2020

(30) Foreign Application Priority Data
Nov. 26, 2019 (JP) 2019-213692

(51) Int. Cl. G08G 1/01; B60W 40/08; B60W 30/18

(52) U.S. Cl. CPC G08G 1/0133; B60W 40/08; B60W 2554/802; G08G 1/0145; B60W 2040/0818; B60W 30/18154

(57) ABSTRACT

An information processing device includes a processor including hardware. The processor is configured to: communicate with an information communication device associated with a mobile object on which a user rides and configured to output user skill information related to driving skill of the user and a sensor configured to sense other mobile objects inside and around an intersection and output sensing information; derive entering timing at which the mobile object enters the intersection based on the sensing information acquired from the sensor and the user skill information acquired from the information communication device; and output timing information including the entering timing of the mobile object to the information communication device before the mobile object enters the intersection.

The present application claims priority to and incorporates by reference the entire contents of Japanese Patent Application No. 2019-213692 filed in Japan on Nov. 26, 2019.

### BACKGROUND

The present disclosure relates to an information processing device, an information processing system, and a computer readable recording medium.

Japanese Patent Application Laid-Open No. 2010-146334 discloses an in-vehicle device that receives transit time period information from an information providing device, acquires a traveling state of an own vehicle as own vehicle information, calculates a safety level of when the own vehicle passes through an intersection based on the received transit time period information and the acquired own vehicle information, determines, based on the calculated safety level, a signal color of a virtual signal indicating a virtual signal, and gives a notification of the virtual signal having the determined signal color.

Japanese Patent Application Laid-Open No. 2009-265832 discloses a drive assist device that predicts a vehicle condition at a right-turn intersection, calculates timing at which a right turn is possible with respect to each condition, with which a right turn is possible, based on a result of the prediction, sets, by a comparison therebetween, the timing at which the right turn is possible and which is instructed to a driver, and assists the driver to make the right turn based on the calculated timing.

### SUMMARY

The techniques disclosed in Japanese Patent Application Laid-Open No. 2010-146334 and Japanese Patent Application Laid-Open No. 2009-265832 notify a safety level and timing at entrance to an intersection. However, it is difficult for a beginner of driving a vehicle, an unskilled user, and the like to accurately determine timing of entering an intersection when being suddenly notified of a safety level or timing since being too busy driving. Thus, there is a possibility that the beginner of driving a vehicle, the unskilled user, and the like cannot enter the intersection at appropriate timing due to driving skill thereof. From this point, there has been a need for a technique that allows a user to previously recognize timing, at which an entrance to an intersection may be safely performed, according to the driving skill.

There is a need for an information processing device, an information processing system, and a computer readable recording medium that are able to previously notify a user of timing, at which an entrance to an intersection may be performed more safely, according to driving skill of a user.

According to one aspect of the present disclosure, there is provided an information processing device including: a processor including hardware, the processor being configured to: communicate with an information communication device associated with a mobile object on which a user rides and configured to output user skill information related to driving skill of the user and a sensor configured to sense other mobile objects inside and around an intersection and output sensing information; derive entering timing at which the mobile object enters the intersection based on the sensing information acquired from the sensor and the user skill information acquired from the information communication device; and output timing information including the entering timing of the mobile object to the information communication device before the mobile object enters the intersection.

According to another aspect of the present disclosure, there is provided an information processing system including: a first device including a first processor including hardware, the first processor being configured to acquire sensing information from a sensor configured to sense other mobile objects inside and around an intersection; a second device including a second processor including hardware, the second processor being configured to acquire user skill information related to driving skill of the user from an information communication device associated with a moving body on which the user rides; and a third device including hardware, the third processor being configured to derive entering timing, at which the mobile object enters the intersection, based on the user skill information acquired by the first device and the sensing information acquired by the second device, and outputting timing information including the entering timing of the mobile object before the mobile object enters the intersection.

### BRIEF DESCRIPTION OF THE DRAWINGS

FIG. 1 is a configuration diagram illustrating an information processing system according to an embodiment;

FIG. 2 is a block diagram schematically illustrating a configuration of a drive assist server according to the embodiment;

FIG. 3 is a block diagram schematically illustrating a configuration of a circular intersection sensor device according to the embodiment;

FIG. 4 is a block diagram schematically illustrating a configuration of a vehicle according to the embodiment;

FIG. 5 is a block diagram schematically illustrating a configuration of a user terminal device according to the embodiment;

FIG. 6 is a sequence diagram illustrating a method of deriving entering timing according to the embodiment;

FIG. 7 is a top view for describing an example of a notification method for entering timing with respect to a circular intersection according to the embodiment;

FIG. 8 is a diagram illustrating a head-up display in order to describe an example of the notification method for entering timing with respect to a circular intersection according to the embodiment; and

FIG. 9 is a top view for describing an example of a notification method for entering timing with respect to a crossroad intersection according to the embodiment.

### DETAILED DESCRIPTION

An Embodiment of the present disclosure will be described below with reference to the drawings. Note that the same reference sign is assigned to the same or corresponding portions in all drawings of the following embodiment. Also, the present disclosure is not limited by the embodiment described below.

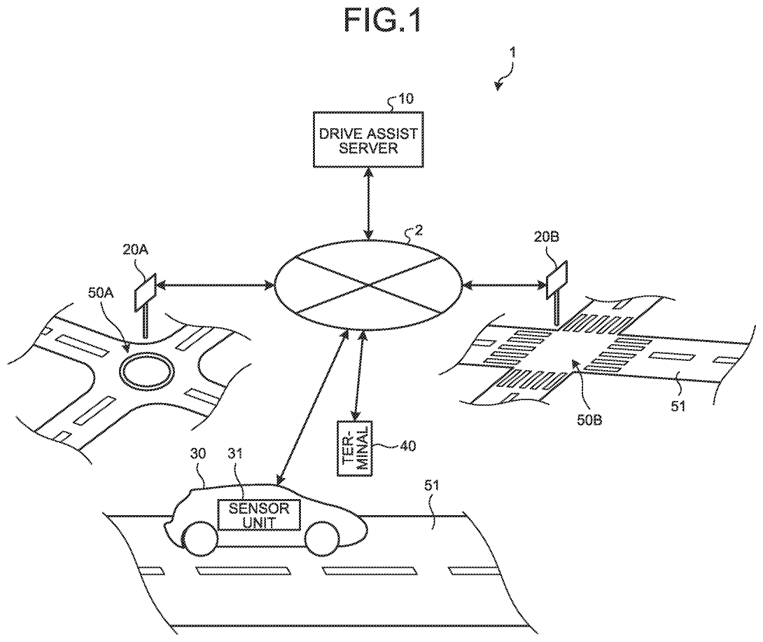

A drive assist system will be described. To the drive assist system, a drive assist device that serves as an information processing device may be applied. FIG. 1 is a diagram illustrating a drive assist system according to the embodiment.

As illustrated in FIG. 1, the drive assist system 1 includes a drive assist server 10, sensor devices 20 (20A and 20B), a vehicle 30 with a sensor unit 31, and a user terminal device 40 that is able to communicate with each other via a network 2.

The network 2 includes an internet network, a mobile phone network, and the like. The network 2 is, for example, a public communication network such as the Internet, and may include other communication networks such as a wide area network (WAN), a telephone communication network of a mobile phone or the like, and a wireless communication network such as WiFi (registered trademark).

The drive assist server 10 as a drive assist device that is an information processing device is a processing server owned, for example, by a navigation service provider. The navigation service provider provides a navigation service to the vehicle 30, or an information provider that provides predetermined information to the vehicle 30. That is, the drive assist server 10 generates and manages information provided to the vehicle 30.

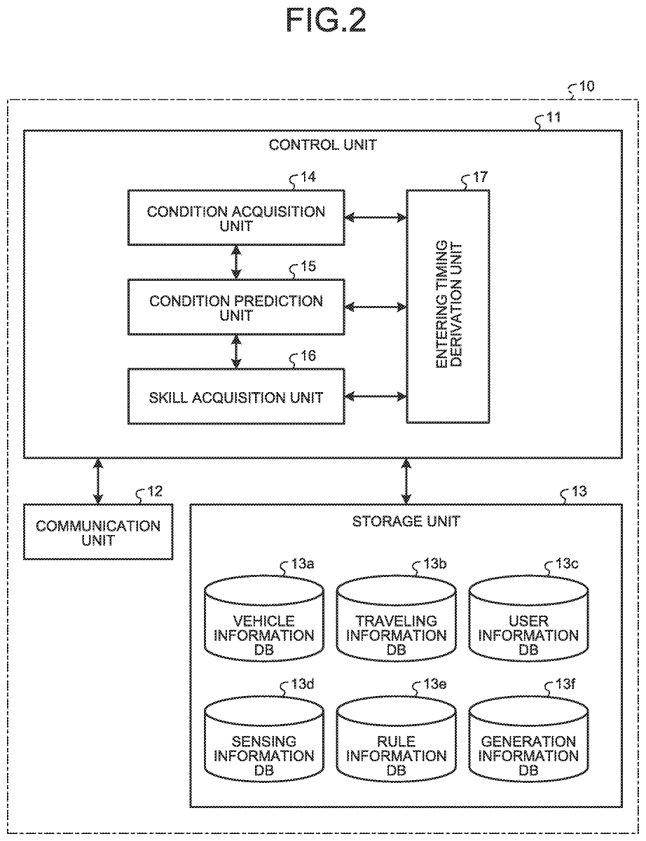

FIG. 2 is a block diagram schematically illustrating a configuration of the drive assist server 10. As illustrated in FIG. 2, the drive assist server 10 includes a computer that includes hardware and that is able to communicate via the network 2. The drive assist server 10 includes a control unit 11, a communication unit 12, and a storage unit 13 that stores various databases. The control unit 11 includes a condition acquisition unit 14, a condition prediction unit 15, a skill acquisition unit 16, and an entering timing derivation unit 17.

More specifically, the control unit 11 includes a processor such as a central processing unit (CPU), a digital signal processor (DSP), or a field-programmable gate array (FPGA), and a main storage unit such as a random access memory (RAM) or a read only memory (ROM). The storage unit 13 includes a storage medium selected from an erasable programmable ROM (EPROM), a hard disk drive (HDD), a removable medium, and the like. Note that a removable medium is, for example, a universal serial bus (USB) memory or a disc recording medium such as a compact disc (CD), a digital versatile disc (DVD), or a Blu-ray (registered trademark) disc (BD). The storage unit 13 may store an operating system (OS), various programs, various tables, various databases, and the like. The control unit 11 loads and executes a program stored in the storage unit 13 in a work area of the main storage unit, and controls each component or the like through the execution of the program. Thus, the control unit 11 may realize functions of the condition acquisition unit 14, the condition prediction unit 15, the skill acquisition unit 16, and the entering timing derivation unit 17 corresponding to a predetermined purpose.

The communication unit 12 as an information acquisition unit is, for example, a local area network (LAN) interface board, or a wireless communication circuit for wireless communication. The LAN interface board or the wireless communication circuit is connected to the network 2, such as the Internet, as a public communication network. The communication unit 12 is connected to the network 2 and communicates with the sensor devices 20A and 20B (hereinafter also referred to as sensor device 20), the vehicle 30, and the user terminal device 40.

With respect to the sensor devices 20, the communication unit 12 receives various kinds of information such as parking position information and transmits a request signal requesting for transmission of predetermined parking position information. With respect to a user terminal device 40 owned by a user, the communication unit 12 transmits information to the user terminal device 40 in utilization of the vehicle 30, and receives user identification information for identification of the user, and various kinds of information from the user terminal device 40.

The communication unit 12 receives various kinds of information such as vehicle identification information, traveling information, and vehicle information from each vehicle 30, and transmits an instruction signal to the vehicle 30. The vehicle identification information includes unique information enabling identification of each vehicle 30. The traveling information includes information related to traveling. The traveling information may include positional information, traveling route information, traveling schedule information, parking schedule information, and traveling history information, but is not necessarily limited to these pieces of information. The traveling information may further include various kinds of information related to traveling of the vehicle 30, such as speed information, acceleration information, traveling distance information, and traveling time information. Note that in a case where the vehicle 30 travels on a predetermined route set in advance, the traveling information may include operation information. The vehicle information may include a state of charge (SOC) and a remaining fuel amount, but is not necessarily limited to these pieces of information. In a case where the vehicle 30 is a rented car or the like, the vehicle information may further include information indicating existence/non-existence of a user that is a borrower, and user identification information of a user that borrows and rides on the vehicle in a case where there is the user that borrows the vehicle.

The storage unit 13 includes various databases including a relational database (RDB), for example. Note that a program of a database management system (DBMS) executed by the above-described processor manages data stored in the storage unit 13, whereby each database (DB) described below is constructed. The storage unit 13 includes a vehicle information database 13a, a traveling information database 13b, a user information database 13c, a sensing information database 13d, a rule information database 13e, and a generation information database 13f.

In the vehicle information database 13a, vehicle information of each vehicle 30 which information is received from the vehicle 30 is stored in an updatable manner in association with the vehicle identification information. Traveling information of each vehicle 30 which information is received from the vehicle 30 is stored in the traveling information database 13b in an updatable manner in association with the vehicle identification information.

In the user information database 13c, the user identification information and user information related to a user may be stored retrievably in association with each other. The user information may include various kinds of information input or selected by a user (hereinafter, user selection information) and information regarding the driving skill of the user (user skill information). The user selection information may include, in addition to the information of an item selected by each user, information related to a start or end of a rental of the vehicle 30 by the user, information of a basic rent set for each user, and the like in a case where the vehicle 30 is a rented car. The user skill information is associated with the user identification information as information of a driving skill level of the user which level is measured when the user drives the vehicle 30, that is, as information of driving skill of the user, and is stored retrievably in the user information database 13c.

The user identification information is stored in the user information database 13c in a retrievable state when assigned to the user. The user identification information includes various kinds of information for identification of each individual user. The user identification information is, for example, a user ID with which individual user may be identified, and is registered in association with user-specific information such as a name and address of the user, or positional information such as longitude and latitude indicating a position or the like of the user. That is, the user identification information includes information necessary to access the drive assist server 10 in transmission/reception of information related to the user. For example, the vehicle 30 or the user terminal device 40 transmits predetermined information such as the user selection information or user skill information to the drive assist server 10 together with the user identification information. In this case, the control unit 11 of the drive assist server 10 retrievably stores the received information in the user information database 13c in association with the user identification information.

The vehicle identification information is stored in a retrievable state in the vehicle information database 13a and the traveling information database 13b after being assigned to the vehicle 30. The vehicle identification information includes various kinds of information for identification of each individual vehicle 30. When the vehicle 30 transmits predetermined information such as positional information or vehicle information to the drive assist server 10 together with the vehicle identification information, the control unit 11 of the drive assist server 10 stores the received predetermined information in a retrievable state in the storage unit 13 in association with the vehicle identification information. In this case, the predetermined information such as positional information or vehicle information may be stored in the vehicle information database 13a or the traveling information database 13b.

Various kinds of sensing information transmitted from the sensor devices 20 and the vehicle 30 are stored in the sensing information database 13d in an addable, superimposable, or rewritable manner. The sensing information is captured image data captured by the sensor devices 20, sensing data sensed thereby, and the like. The sensing information includes captured image data and sensing data of the circular intersection (rotary intersection) 50A and the crossroad intersection 50B that are imaged and sensed by the sensor devices 20. Note that the circular intersection 50A includes a traffic circle (roundabout). An at-grade intersection-type intersection 50 includes various kinds of intersections in which a plurality of roads 51 intersects with each other and which are, for example, a three-forked road, a crossroad, and a five-forked road. The crossroad intersection 50B is a kind of the at-grade intersection-type intersection in which a plurality of roads intersects with each other at grade. Similarly, the sensing information includes captured image data and sensing data of the circular intersection 50A and the crossroad intersection 50B that are imaged and sensed by the sensor unit 31 of the vehicle 30. Also, the sensing information includes information acquired by inter-vehicle communication by a plurality of vehicles 30. The inter-vehicle communication between the plurality of vehicles 30 enables transmission and reception of captured image data and sensing data between the vehicles 30. The drive assist server 10 periodically or appropriately acquires the sensing information from each sensor device 20 or each vehicle 30. In a case where the drive assist server 10 acquires the sensing information, the acquired sensing information is retrievably stored into the sensing information database 13d.

The rule information database 13e retrievably stores rule information related to traffic rules applied to positions where the vehicles 30 travel. The rule information is, for example, information of a priority rule indicating which of a vehicle 30 entering a circular portion of the circular intersection 50A and a vehicle 30 passing through the circular portion is prioritized, a rule based on a sign, and a rule indicating whether a course may be changed. The rule information database 13e also stores information related to various kinds of intersections such as the circular intersection 50A and the crossroad intersection 50B (hereinafter, also collectively referred to as intersection 50) (hereinafter, intersection information) retrievably. More specifically, for example, the intersection information may include necessary information selected from a position, width, road width, size, and presence/absence of a lane at the intersection 50, and a radius, an entering angle, a function of a rotary island, and the like in a case of the circular intersection 50A. The intersection information may further include information related to a condition such as existence/non-existence of an obstacle and a road condition at the intersection 50.

The generation information database 13f stores, in a readable manner, various kinds of information generated by the condition acquisition unit 14, the condition prediction unit 15, the skill acquisition unit 16, and the entering timing derivation unit 17 of the control unit 11. Details of the various kinds of information generated by the control unit 11 will be described later.

The condition acquisition unit 14 generates condition information related to a traffic condition that is a condition of the vehicles 30 inside and around the intersection 50 based on the sensing information stored in the sensing information database 13d. The condition information includes positional information and speed information of vehicles 30 as other mobile objects existing inside and around the intersection 50, that is, information of traffic conditions of various vehicles 30 within a predetermined area including the intersection 50. Note that the other mobile objects include pedestrians, bicycles, and the like. The condition acquisition unit 14 generates condition information from the sensing information by information processing according to a predetermined program. The condition acquisition unit 14 may store the generated condition information into the generation information database 13f. As a result, the control unit 11 may read various kinds of condition information from the storage unit 13. Note that the condition information may be generated by the sensor devices 20 or the vehicles 30 and transmitted to the drive assist server 10. As a result, a processing load on the drive assist server 10 may be reduced.

Note that the condition acquisition unit 14 may include a learned model generated by machine learning such as deep learning, for example. This learned model may be generated by machine learning with input/output data sets of predetermined input parameters and output parameters being teacher data. Here, as the input parameters, for example, various kinds of sensing information may be used. The output parameters may be predetermined condition information.

The condition prediction unit 15 predicts a traffic condition in ten-odd seconds and a several tens of seconds from the present at the intersection 50 by simulation based on the intersection information stored in the rule information database 13e. The condition prediction unit 15 generates traffic conditions inside and around the intersection 50, which condition is predicted by the simulation, as prediction information and performs an input thereof to the entering timing derivation unit 17. The condition prediction unit 15 may store the generated prediction information into the generation information database 13f. On the one hand, the condition prediction unit 15 determines whether a vehicle 30 on which the user rides enters the intersection 50. The condition prediction unit 15 may determine an entrance of the vehicle 30 into the intersection 50, for example, based on traveling information of the vehicle 30, or after the intersection 50 is detected by the sensor unit 31. Also, the determination of the entrance to the intersection 50 may be made between the time immediately before the vehicle 30 enters the intersection 50 and the time a several tens of seconds before the entrance, but is not necessarily limited to these kinds of timing. Note that the prediction information may be generated by the sensor devices 20 or the vehicle 30 and transmitted to the drive assist server 10. As a result, a processing load on the drive assist server 10 may be reduced.

The skill acquisition unit 16 acquires user information transmitted from the vehicle 30. The skill acquisition unit 16 derives at least one traveling pattern based on driving skill of the user at a predetermined intersection 50 from user skill information included in the user information. The skill acquisition unit 16 may further derive a traveling pattern based on sensing information acquired from the sensor devices 20 (described later). The skill acquisition unit 16 outputs information of the derived traveling pattern of the user (travel pattern information) to the entering timing derivation unit 17. The skill acquisition unit 16 may store the generated traveling pattern information into the generation information database 13f. The traveling pattern information includes necessary information among pieces of information such as a steering angle of the vehicle 30 by the user, operation timing or a reaction speed of each operation unit such as an accelerator or a brake, a speed, acceleration, a traveling route, an entering route into the intersection 50 of the vehicle 30, and the like. The skill acquisition unit 16 may include a learned model generated by machine learning such as deep learning, for example. For example, driving skill information of various users may be used as input parameters and various traveling patterns may be used as output parameters in the teacher data of this learned model.

Based on the condition information acquired from the condition prediction unit 15, the traveling pattern information acquired from the skill acquisition unit 16, and the rule information at the intersection 50, the entering timing derivation unit 17 generates timing information that is timing at which the vehicle 30 may safely enter the intersection 50 in the entrance thereto. Here, the timing information includes information of entering timing corresponding to driving skill of the vehicle 30 by the user and the traffic conditions inside and around the intersection 50. That is, the timing information includes unique entering timing information that differs for each vehicle 30, each user, and each intersection 50. The timing information may include a relative positional relationship between the vehicle 30 on which the user rides and another vehicle 30 traveling inside or around the intersection 50, more specifically, timing of entering the front or behind of a predetermined another vehicle 30, for example. Also, the timing information may include remaining time before the vehicle 30 on which the user rides enters the intersection 50, more specifically, information at the present or in a predetermined period, for example. The timing information may include information of various kinds of timing as long as the timing is for the vehicle 30 on which the user rides to enter the intersection 50. The entering timing derivation unit 17 may store the generated timing information into the generation information database 13f. On the one hand, the entering timing derivation unit 17 transmits the generated timing information to at least one of the vehicle 30 and the user terminal device 40 via the communication unit 12.

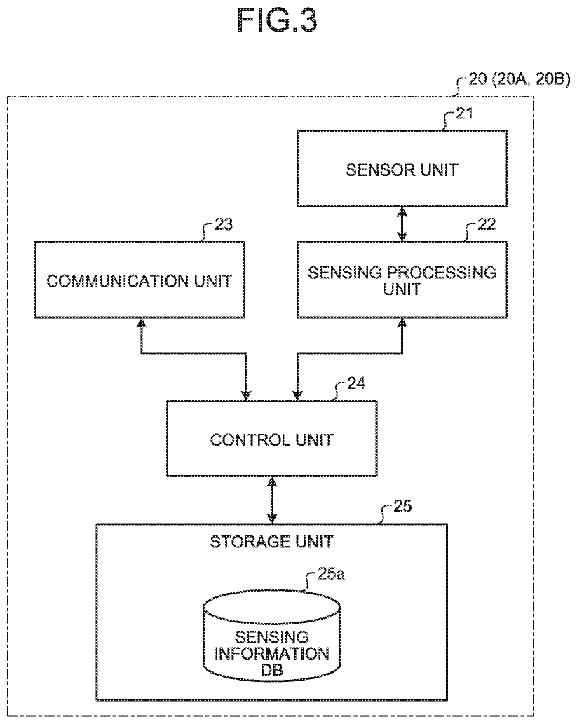

The sensor devices 20 (20A and 20B) illustrated in FIG. 1 acquire information of an area inside or around the circular intersection 50A or the crossroad intersection 50B by sensing processing such as imaging. FIG. 3 is a block diagram schematically illustrating a configuration of a sensor device 20. As illustrated in FIG. 3, the sensor device 20 has a configuration with which communication is possible via the network 2. The sensor device 20 includes a sensor unit 21, a communication unit 23, a control unit 24, and a storage unit 25.

For example, the sensor unit 21 includes an imaging device such as an imaging camera that may image a predetermined area, a millimeter-wave radar or a laser radar that may perform scanning electronically with a beam and may detect existence/non-existence of an obstacle, and the like. Note that any device may be employed as long as the device may sense information related to traveling of each vehicle 30 on the road 51. A sensing processing unit 22 is a processing unit that controls sensing processing by the sensor unit 21. A result of the sensing processing executed by the sensor unit 21 is generated as sensing information by the sensing processing unit 22. The sensing information processed by the sensing processing unit 22 is stored retrievably into a sensing information database 25a of the storage unit 25. Note that the sensing processing unit 22 may further include a storage unit. Also, the sensor unit 21 and the sensing processing unit 22 may be configured separately from the communication unit 23, the control unit 24, and the storage unit 25.

The communication unit 23 is physically similar to the communication unit 12 described above. The communication unit 23 is connected to the network 2 and communicates with the drive assist server 10. The communication unit 23 transmits the sensing information to the drive assist server 10. Note that information transmitted by the communication unit 23 is not limited to these pieces of information.

The control unit 24 and the storage unit 25 are physically similar to the control unit 11 and the storage unit 13 described above, respectively. The storage unit 25 stores, as a sensing information database 25a, sensing information related to the inside and periphery of the intersection 50 sensed by the sensor unit 21. The control unit 24 may generate condition information by executing image processing or information processing on the sensing information acquired from the sensing processing unit 22 and stored in the sensing information database 25a of the storage unit 25. The condition information includes information related to traffic conditions of various vehicles 30 inside and around the intersection 50 in the area where the sensor unit 21 performs the sensing processing. The sensing information database 25a of the storage unit 25 may store the condition information generated by the control unit 24.

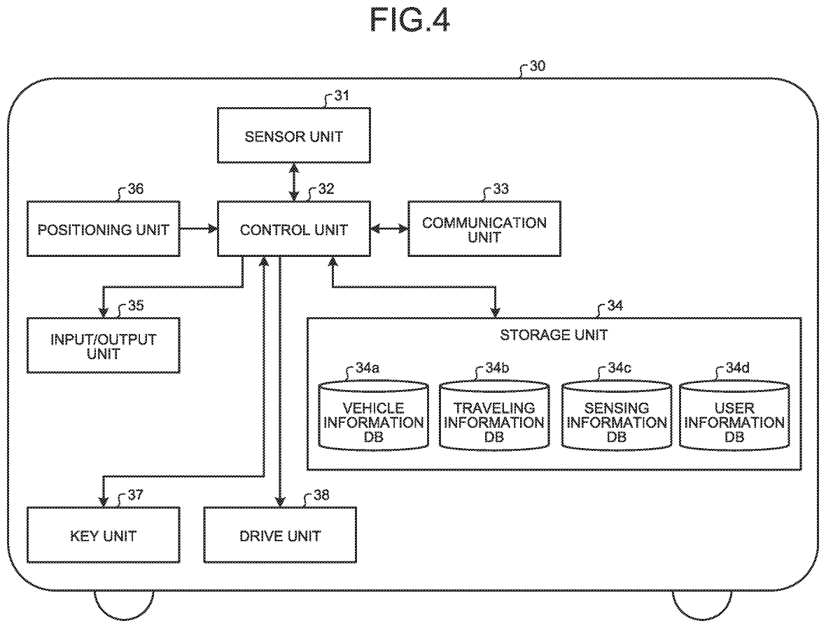

A vehicle 30 as a mobile object is a vehicle that travels by driving by a driver. The vehicle 30 as a mobile object may be an autonomous traveling vehicle capable of autonomous traveling according to a given traveling command. FIG. 4 is a block diagram schematically illustrating a configuration of the vehicle 30. As illustrated in FIG. 4, the vehicle 30 includes a sensor unit 31, a control unit 32, a communication unit 33, a storage unit 34, an input/output unit 35, a positioning unit 36, a key unit 37, and a drive unit 38.

The sensor unit 31 includes a sensor that is related to traveling of the vehicle 30 and that is, for example, a vehicle speed sensor or an acceleration sensor, a vehicle interior sensor that may detect various conditions in the vehicle interior, an imaging device that may photograph the vehicle interior or the vehicle exterior and that is, for example, an imaging camera, and the like. In the present embodiment, for example, the imaging device images a scene in the vehicle exterior, whereby image data as sensing information is accumulated in the storage unit 34. Note that the sensing information is not limited to the image data as long as information related to a condition inside and around the circular intersection 50A or the crossroad intersection 50B may be acquired.

The control unit 32, the communication unit 33, and the storage unit 34 are physically similar to the control unit 11, the communication unit 12, and the storage unit 13 described above, respectively. The control unit 32 integrally controls operations of various components mounted on the vehicle 30. The communication unit 33 as a communication terminal of the vehicle 30 includes, for example, a data communication module (DCM) or the like that communicates with the drive assist server 10 or the sensor devices 20 by wireless communication via the network 2.

The storage unit 34 includes a vehicle information database 34a, a traveling information database 34b, a sensing information database 43c, and a user information database 34d. The vehicle information database 34a stores, in an updatable manner, various kinds of information including an SOC, a remaining fuel amount, vehicle characteristic information that characterizes the vehicle 30, and the like. The traveling information database 34b stores, in an updatable manner, various kinds of information including traveling information measured and generated by the control unit 32 based on various kinds of information acquired from the sensor unit 31, the positioning unit 36, and the drive unit 38. In the sensing information database 34c, captured image data captured by the sensor unit 31, sensing data sensed thereby, and the like are stored in a superimposable or rewritable manner.

The input/output unit 35 includes a touch panel display, a speaker microphone, and the like. According to control by the control unit 32, the input/output unit 35 as an output unit may notify the outside of predetermined information by displaying a character, figure, and the like on a screen of the touch panel display, or outputting sound from the speaker microphone. Moreover, the input/output unit 35 may be a head-up display, a wearable device having an augmented reality (AR) function, or the like. Also, the input/output unit 35 as an input unit may input predetermined information to the control unit 32 when a user or the like operates the touch panel display or emits sound toward the speaker microphone. A wearable device having an augmented reality (AR) function, or the like may be also employed as the input/output unit 35 as the input unit.

For example, the positioning unit 36 receives a radio wave from a global positioning system (GPS) satellite and detects a position of the vehicle 30. A position or route of the vehicle 30 which position or route is detected by the positioning unit 36 functioning as a positional information acquisition unit of the vehicle 30 is stored retrievably in the vehicle information database 34a as positional information or traveling route information in the traveling information. Note that a method in which light detection and ranging/laser imaging detection and ranging (LiDAR) is combined with a three-dimensional digital map may be employed as a method of detecting a position of the vehicle 30.

Note that although including the input/output unit 35 and the positioning unit 36 as separate functions, the vehicle 30 according to the present embodiment may include, instead of the input/output unit 35 and the positioning unit 36, an in-vehicle navigation system with a communication function which system has both of functions of the input/output unit 35 and the positioning unit 36.

The key unit 37 may execute locking or unlocking of the vehicle 30, for example, by authentication with the user terminal device 40 based on BLE authentication information. The drive unit 38 is a conventionally known drive unit necessary for traveling of the vehicle 30. Specifically, the vehicle 30 includes an engine as a drive source, and the engine may generate electric power with an electric motor or the like by driving due to combustion of fuel. The generated electric power is charged in a rechargeable battery. Moreover, the vehicle 30 includes a drive transmission mechanism that transmits driving force of the engine, driving wheels for traveling, and the like.

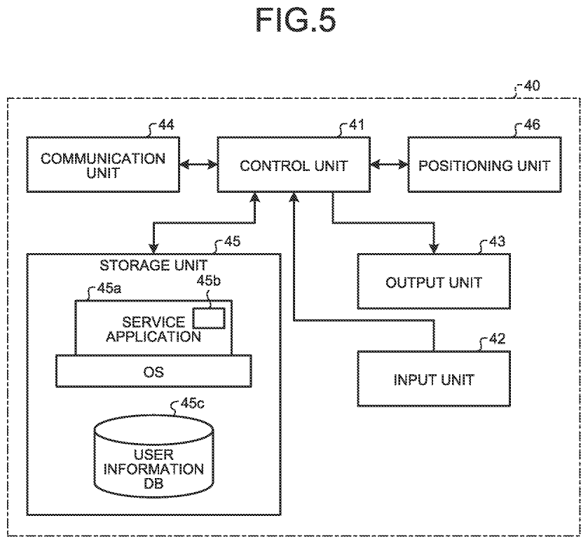

The user terminal device 40 as a terminal that is included in the information communication unit is operated by the user. The user terminal device 40 transmits various kinds of information such as user information including user identification information and user selection information to the drive assist server 10, for example, by a call by a communication application using various kinds of data or sound. The user terminal device 40 may receive various kinds of information such as traveling route information and, when necessary, electronic key data or the like from the drive assist server 10. Note that the user terminal device 40 may be an in-vehicle terminal fixed to the vehicle 30, a mobile terminal that may be carried by a user, or a terminal that may be attached/detached at a predetermined portion of the vehicle 30. FIG. 5 is a block diagram schematically illustrating a configuration of the user terminal device 40 illustrated in FIG. 1.

As illustrated in in FIG. 5, the user terminal device 40 includes a control unit 41, an input unit 42, an output unit 43, a communication unit 44, a storage unit 45, and a positioning unit 46 that are communicably connected to each other. The control unit 41, the communication unit 44, and the storage unit 45 are physically similar to the control unit 11, the communication unit 12, and the storage unit 13 described above, respectively. The positioning unit 46 is physically similar to the positioning unit 36 described above.

The control unit 41 may execute various programs stored in the storage unit 45, and may store various tables, various databases, and the like in the storage unit 45. The control unit 41 loads and executes an OS and a service application 45a stored in the storage unit 45 in a work area of a main storage unit, and integrally controls operations of the input unit 42, the output unit 43, the communication unit 44, the storage unit 45, and the positioning unit 46. In the present embodiment, a locking/unlocking request program 45b is embedded into the service application 45a, for example, in a form of a software development kit (SDK).

The locking/unlocking request program 45b is executed by the service application 45a of the user terminal device 40 and, for example, authentication based on BLE authentication information is performed between the user terminal device 40 and the key unit 37, whereby the vehicle 30 may be locked or unlocked. Thus, in the vehicle 30, it becomes possible to acquire user information of the user that drives or rides on the vehicle 30. Note that various methods may be employed for the locking/unlocking of the vehicle 30 via communication between the user terminal device 40 and the key unit 37.

The input unit 42 includes, for example, a keyboard, a touch panel keyboard that is embedded in the output unit 43 and that detects a touch operation on a display panel, a sound input device that enables a call with the outside, or the like. Here, the call with the outside not only includes a call with another user terminal device 40 but also includes, for example, a call with an operator that operates the drive assist server 10 or with an artificial intelligence system.

The output unit 43 includes, for example, an organic EL panel, a liquid crystal display panel, or the like and notifies the outside of information by displaying a character, a figure, and the like on the display panel. The output unit 43 may include a speaker, a sound output device, or the like that outputs sound. Note that the input unit 42 and the output unit 43 may be configured similarly to the input/output unit 35 described above.

The communication unit 44 may transmit/receive various kinds of information such as the user identification information, the user selection information, and sound data to/from an external server such as the drive assist server 10, or the vehicle 30 via the network 2. The storage unit 45 has a user information database 45c and may store the user information in association with the user identification information. The positioning unit 46 as a positional information acquisition unit of the user terminal device 40 may detect a position of the user terminal device 40, for example, by communication with a GPS satellite. The detected positional information may be transmitted to the drive assist server 10 or the vehicle 30 via the network 2 as user position information in association with the user identification information.

As the user terminal device 40 described above, specifically, various devices that may be carried by a user and that are, for example, a mobile phone such as a smartphone, a tablet-type information terminal, and the like may be used. Also, the user terminal device 40 may be an in-vehicle terminal fixed to the vehicle 30, a mobile terminal that may be carried by a user, or an operation terminal that may be attached/detached at a predetermined portion of the vehicle 30.

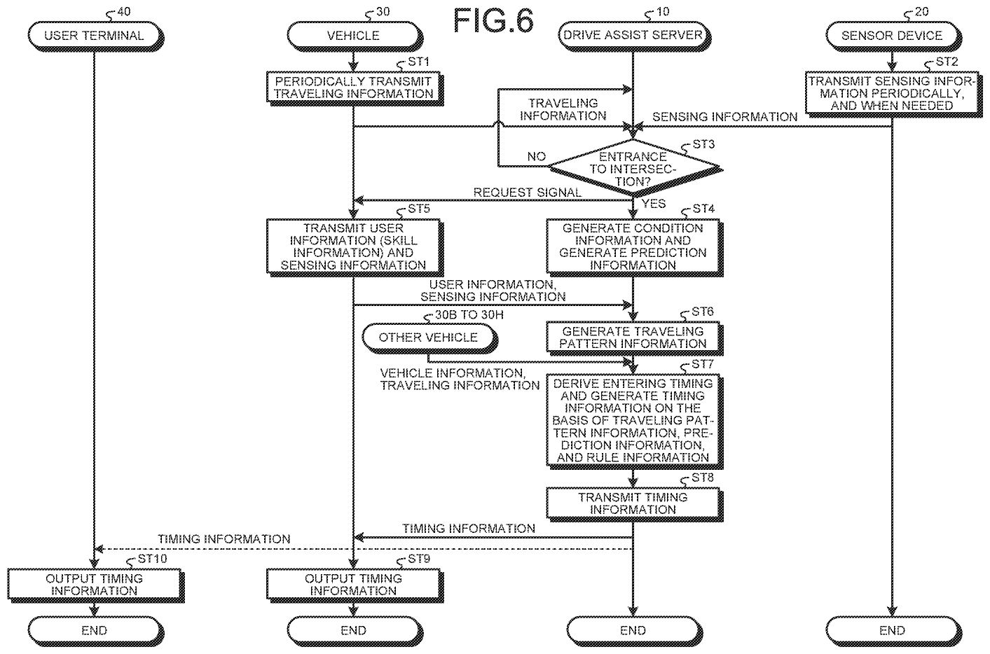

Next, a timing derivation method executed by the drive assist server 10 of the drive assist system 1 configured in the above manner will be described. FIG. 6 is a sequence diagram illustrating a timing derivation method according to the one embodiment. Note that transmission and reception of information are performed via the network 2 and each of the communication units 23, 33, and 44 in the following description, but repetitive description on this point will be omitted. Also, when information is transmitted from each vehicle 30 or each user terminal device 40, vehicle identification information or user identification information for identification of the vehicle 30 or the user terminal device 40 is also transmitted in association with the transmitted information. However, repetitive description on this point is also omitted.

As illustrated in FIG. 6, in Step ST1, a vehicle 30 periodically transmits traveling information to the drive assist server 10. Note that sensing information such as captured image data captured, for example, by an imaging device of the sensor unit 31 and sensing data may be also transmitted to the drive assist server 10. In Step ST2, a sensor device 20 periodically transmits, to the drive assist server 10, sensing information such as image data of a predetermined area including a periphery of the intersection 50 imaged, for example, by the imaging device or the like of the sensor unit 21. Step ST1 and ST2 are periodically executed in the timing derivation method, and may be executed in the same order, reverse order, or in parallel. The drive assist server 10 that acquires the sensing information stores the acquired sensing information into the sensing information database 13d.

A transition to Step ST3 is made, and the condition prediction unit 15 of the drive assist server 10 determines whether the vehicle 30 on which the user rides enters the intersection 50 within a predetermined period. The condition prediction unit 15 may make determination of the entrance of the vehicle 30 into the intersection 50, for example, after a time point at which the sensor unit 31 detects the intersection 50 or at any time.

In a case where the condition prediction unit 15 determines that the vehicle 30 on which the user rides does not enter the intersection 50 within the predetermined period (Step ST3: No), Step ST1 and ST2 are repeatedly executed. On the one hand, in a case where the condition prediction unit 15 determines that the vehicle 30 on which the user rides enters the intersection 50 within the predetermined period, the condition acquisition unit 14 or the skill acquisition unit 16 that acquires a result of the determination transmits a request signal for information to the vehicle 30, and a transition to Step ST4 is made.

In Step ST4, the condition acquisition unit 14 of the drive assist server 10 generates condition information related to the intersection 50 based on the sensing information acquired from the sensor device 20. The sensing information acquired by the condition acquisition unit 14 is sensing information related to the intersection 50 an entrance into which is determined. The condition acquisition unit 14 outputs the generated condition information to the condition prediction unit 15. The condition acquisition unit 14 may store the generated condition information into the generation information database 13f in association with positional information of the intersection 50. Note that the condition acquisition unit 14 may generate condition information based on the acquired sensing information and traveling information of another vehicle 30 traveling around the intersection 50.

The condition prediction unit 15 to which condition information is input from the condition acquisition unit 14 predicts, by simulation based on the acquired condition information related to the intersection 50, a traffic condition in a predetermined period such as ten-odd seconds from the present at the intersection 50 where the vehicle 30 enters. The condition prediction unit 15 inputs the predicted traffic condition as prediction information to the entering timing derivation unit 17. The condition prediction unit 15 may store the generated prediction information into the generation information database 13f in association with the positional information of the intersection 50.

On the other hand, in Step ST5, the control unit 32 of the vehicle 30 that receives the request signal reads user information including user skill information from the user information database 34d and performs transmission thereof to the drive assist server 10. Similarly, the control unit 32 reads sensing information from a sensing information database 34c and performs transmission thereof to the drive assist server 10. Note that Step ST4 and ST5 may be performed in the same order, in the reverse order, or in parallel. For example, before the drive assist server 10 executes the processing of Step ST4, the vehicle 30 may transmit the user information and sensing information to the drive assist server 10.

When a transition to Step ST6 is made, the skill acquisition unit 16 first acquires user skill information from the received user information. From the acquired user skill information, the skill acquisition unit 16 derives at least one traveling pattern based on driving skill of the user at the entering intersection 50 and generates traveling pattern information. The skill acquisition unit 16 outputs the generated traveling pattern information to the entering timing derivation unit 17. The skill acquisition unit 16 may store the generated traveling pattern information into the generation information database 13f in association with the positional information of the intersection 50 and the user identification information. The skill acquisition unit 16 may further derive a traveling pattern based on the sensing information acquired from the sensor device 20 and related to the intersection 50 where the vehicle 30 on which the user rides enters within the predetermined period.

A transition to Step ST7 is made, and the entering timing derivation unit 17 retrieves and acquires rule information from the rule information database 13e based on the positional information of the intersection 50. That is, the entering timing derivation unit 17 reads rule information such as a law or a traffic rule applied at a position where the intersection 50 exists. The entering timing derivation unit 17 derives entering timing at which the vehicle 30 may safely enter the intersection 50 based on the acquired traveling pattern information, prediction information, and rule information. The entering timing derivation unit 17 generates the entering timing of the vehicle 30 into the intersection 50 as timing information. The entering timing derivation unit 17 may store a generated timing information into the generation information database 13f. Note that the entering timing derivation unit 17 may acquire vehicle information of another vehicle 30 (such as vehicle 30H) traveling inside or around the intersection 50.

Here, the timing information generated by the entering timing derivation unit 17 includes information on entering timing corresponding to a traffic condition inside and around the intersection 50. That is, the timing information includes unique entering timing information that differs for each vehicle 30, each user, and each intersection 50. The timing information may include a relative positional relationship between the vehicle 30 on which the user rides and another vehicle 30 traveling inside or around the intersection 50, more specifically, timing of entering the front or behind of a predetermined another vehicle 30, for example. Also, the timing information may include remaining time before the vehicle 30 on which the user rides enters the intersection 50, more specifically, information at the present or in a predetermined period, for example. The timing information may include information of various kinds of timing as long as the timing is for the vehicle 30 on which the user rides to enter the intersection 50. The entering timing derivation unit 17 may store the generated timing information into the generation information database 13f. On the one hand, a transition to Step ST8 is made, and the entering timing derivation unit 17 transmits the generated timing information to at least one of the vehicle 30 and the user terminal device 40 via the communication unit 12.

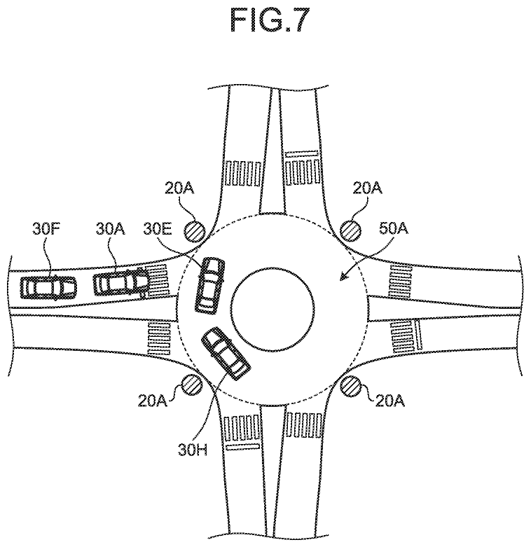

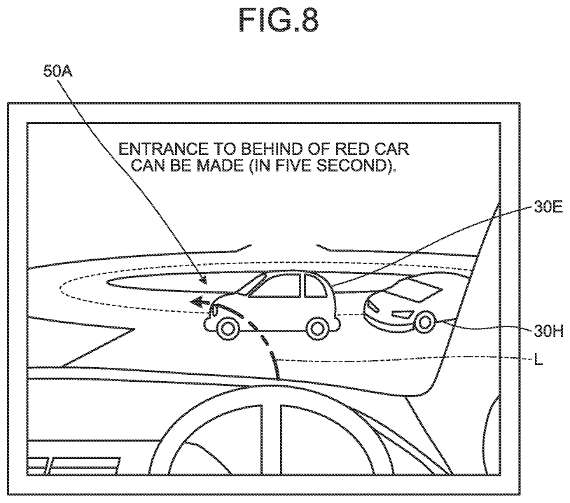

Then, in Step ST9, the control unit 32 of the vehicle 30 outputs the received timing information from the input/output unit 35. FIG. 7 and FIG. 8 are a top view for describing an example of a notification method for entering timing to the circular intersection 50A and a diagram illustrating a head-up display, respectively.

As illustrated in FIG. 7, a traffic condition inside and around the circular intersection 50A is sensed by the sensor device 20A. Here, for example, the vehicle 30A on which the user rides tries to enter the circular intersection 50A. On the one hand, vehicles 30E and 30H are traveling in a circular portion of the circular intersection 50A. Here, it is assumed that the vehicle 30H is a vehicle having a red body and a traffic rule at this circular intersection 50A gives priority to a vehicle traveling in the circular portion. In this case, timing information is, for example, information indicating that an entrance along an entering route L is possible after the prioritized another vehicle 30H passes through at the circular intersection 50A. More specifically, for example, as illustrated in FIG. 8, the timing information includes what indicates that “an entrance to the behind of a red car can be made” and what indicates that the entrance is made along the entering route L, and these pieces of information may be displayed on a head-up display. That is, the control unit 32 of the vehicle 30 displays at least a part of the timing information, that is, information sufficient for the user to safely drive the vehicle 30A on the head-up display of the input/output unit 35. Here, as illustrated in FIG. 8, the time until the entrance to the circular intersection 50A may be displayed, or the remaining time may be counted down. Also, instead of being displayed on the head-up display, the timing information may be displayed on a display of a car navigation device or may be output as sound through a speaker. As a result, the user that drives the vehicle 30A may previously recognize the timing to safely enter the circular intersection 50A.

Furthermore, as illustrated in FIG. 7, the drive assist server 10 may transmit timing information indicating that “an entrance can be made after the preceding vehicle” to the vehicle 30F following the vehicle 30A, for example. In this case, before the entrance by the vehicle 30A, a user that rides on the vehicle 30F may recognize that it is possible to enter the circular intersection 50A subsequent to the vehicle 30A. As a result, the user that rides on the vehicle 30F may drive the vehicle 30F in such a manner as to enter the circular intersection 50A more safely without being panicked.

Also, in a case where the user terminal device 40 receives the timing information, a transition to Step ST10 is made and the control unit 41 outputs the received timing information from the output unit 43. In this case, the output unit 43 outputs the timing information including what is described above and indicates that “an entrance to the behind of a red car can be made” and contents indicating in which entering route the entrance is made. Note that the timing information may be displayed on the display of the output unit 43 or may be output as sound through a speaker based on a car navigation application in the user terminal device 40.

At-Grade Intersection-Type Intersection

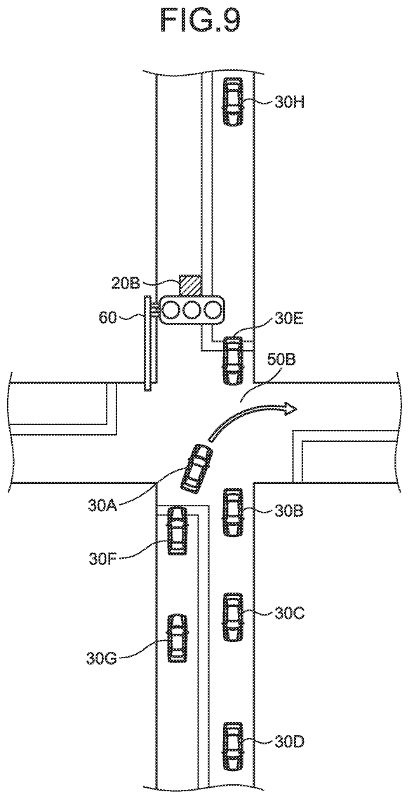

Next, in Step ST9 and ST10 illustrated in FIG. 6, the user that rides on the vehicle 30A may be notified of timing information similarly with respect to the crossroad intersection 50B. FIG. 9 is a top view illustrating an example of a case where a vehicle 30A enters the crossroad intersection 50B.

At the crossroad intersection 50B illustrated in FIG. 9, a traffic signal 60 is provided with a sensor device 20B. The sensor device 20B may sense the inside and periphery of the crossroad intersection 50B. As a result, the sensor device 20B transmits, to the drive assist server 10, sensing information including captured image data of other vehicles 30A to 30H traveling inside and around the crossroad intersection 50B. Furthermore, the sensing information acquired by sensing by the sensor unit 31 of the vehicle 30A may be transmitted to the drive assist server 10.

As illustrated in FIG. 9, in a case where the vehicle 30A enters the crossroad intersection 50B, the vehicle 30E starts entering the crossroad intersection 50B in an oncoming lane. In this case, for example, in a case where the vehicle 30E that moves straight is prioritized in the rule at the crossroad intersection 50B, the entering timing derivation unit 17 generates timing information indicating that “an entrance can be made after a leading vehicle in the oncoming lane passes through the side”. The input/output unit 35 of the vehicle 30A outputs this timing information. Here, an entering route (bold white line in FIG. 9) may be output together.

Also, in a case of being able to acquire timing at which a lighting color of the traffic signal 60 is switched, lighting time, and the like as the rule information, the entering timing derivation unit 17 of the drive assist server 10 may generate timing information based on the timing of switching of the lighting color of the traffic signal 60.

Also, for example, in a case where user skill information of the user driving the vehicle 30A includes information such that it is possible to pass through the crossroad intersection 50B in a short period, the entering timing derivation unit 17 may generate timing information such that entering and passing through the crossroad intersection 50B may be performed at timing at which the vehicles 30D, 30C, and 30B pass through. On the contrary, in a case where the user skill information of the user driving the vehicle 30A includes information such that it takes time to pass through the crossroad intersection 50B, timing information such that entering and passing through the crossroad intersection 50B may be performed at timing at which the vehicle 30H further passes through after the vehicles 30D, 30C, 30B, and 30E pass through may be generated. Furthermore, with respect to the vehicle 30F or the vehicle 30G, the entering timing derivation unit 17 may generate timing information such that entering may be performed, for example, at timing in 10 seconds after the vehicle 30A passes through the crossroad intersection 50B.

According to the embodiment described above, driving pattern information is generated based on user skill information, and timing information is generated based on the traveling pattern information and prediction information. Thus, based on driving skill of a user, it is possible to previously notify the user of timing at which it is possible to safely enter the intersection 50. Also, since it is possible to notify the user on the vehicle 30A of entering timing in a relative relationship with movements of the other vehicles 30B to 30H and of remaining time until the entering is started, it becomes possible to more easily determine entering timing even in a case where the driving skill of the user is low, and entering and passing through the intersection 50 may be performed more safely.

Although an embodiment of the present disclosure has been described above in detail, the present disclosure is not limited to the above-described embodiment, and various modifications based on a technical idea of the present disclosure may be made. For example, the numerical values mentioned in the above-described embodiment are merely examples, and different numerical values may be used when necessary.

In the above-described embodiment, the drive assist server 10 executes the functions of the condition acquisition unit 14, the condition prediction unit 15, the skill acquisition unit 16, and the entering timing derivation unit 17. However, a control unit 32 of a vehicle 30 may execute a part or all of these functions. Similarly, a control unit 41 of a user terminal device 40 may execute a part or all of the functions of the condition acquisition unit 14, the condition prediction unit 15, the skill acquisition unit 16, and the entering timing derivation unit 17.

Also, as another embodiment, each of functions of a condition acquisition unit 14, a condition prediction unit 15, a skill acquisition unit 16, and an entering timing derivation unit 17 may be divided and executed by a plurality of devices that may communicate with each other via a network 2. For example, at least a part of the function of the condition acquisition unit 14 may be executed by a first device having a first processor. At least a part of the function of the condition acquisition unit 14 may be executed by a fifth device having a fifth processor. At least a part of the function of the skill acquisition unit 16 may be executed by a second device having a second processor. At least a part of the function of the entering timing derivation unit 17 may be executed by a third device having a third processor. A part of the function of the entering timing derivation unit 17 and a function of a rule information database 13e of a storage unit 13 may be executed by a fourth device having a fourth processor and a first memory. At least a part of the function of the condition prediction unit 15 may be executed by a sixth device having a sixth processor. At least a part of the function of the skill acquisition unit 16 may be executed by the second device having the second processor. A part of the function of the skill acquisition unit 16 and a part of a function of a generation information database 13f of the storage unit 13 may be executed by a seventh device having a seventh processor and a second memory. Here, the first to seventh devices may be able to transmit and receive information to and from each other via a network 2 or the like. In this case, at least one of the first to seventh devices, for example, at least one of the first device and the second device may be mounted on the vehicle 30.

In the above-described embodiment, a program for executing an entering timing derivation method may be recorded in a recording medium that is read by a computer or other machines or devices (hereinafter referred to as a computer or the like). A processor of the computer or the like is caused to read and execute the program in the recording medium and the computer or the like functions as a drive assist server 10 or a control unit of a vehicle 30. Here, the recording medium that is read by the computer or the like indicates a non-transitory recording medium that may accumulate information such as data and a program by an electrical, magnetic, optical, mechanical, or chemical action and that may be read by the computer or the like. Examples of such a recording medium that may be removed from the computer or the like include a flexible disk, a magneto-optical disk, a CD-ROM, a CD-R/W, a DVD, a BD, a DAT, a magnetic tape, a memory card such as a flash memory, and the like. Also, recording media fixed to the computer or the like include a hard disk, a ROM, and the like. Moreover, a solid state drive (SSD) may be used as a recording medium removable from the computer or the like, and also as a recording medium fixed to the computer or the like.

Also, in a vehicle according to the embodiment, the “unit” described above may be read as a “circuit” or the like. For example, the communication unit may be read as a communication circuit.

Also, a program to be executed by the information processing device according to the embodiment is provided as file data in an installable or executable format while being recorded in a computer-readable recording medium such as a CD-ROM, a flexible disk (FD), a CD-R, a digital versatile disk (DVD), a USB medium, or a flash memory.

Also, the program to be executed by the information processing device according to the embodiment may be stored in a computer connected to a network such as the Internet and provided by being downloaded through the network.

Note that in the description of the flowcharts in the specification, although the expressions “first”, “then”, “subsequently”, and the like are used to clarify processing order of the steps, the processing order required to carry out the present embodiment is not defined uniquely by these expressions. That is, the processing order in the flowcharts described in the present description may be changed in a range without contradiction.

According to the present disclosure, it becomes possible to previously notify a user of timing, at which an entrance to an intersection may be more safely performed, according to driving skill of the user.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a processor comprising hardware, the processor being configured to:
communicate with: an information communication device associated with a mobile object on which a user rides and configured to output user skill information related to driving skill of the user; and a sensor configured to sense other mobile objects inside and around an intersection and output sensing information;
derive entering timing at which the mobile object enters the intersection based on the sensing information acquired from the sensor and the user skill information acquired from the information communication device; and
output timing information including the entering timing of the mobile object to the information communication device before the mobile object enters the intersection.

2. The information processing device according to claim 1, further comprising
a memory configured to store rule information related to the intersection, wherein
the processor is configured to:
read the rule information from the memory; and
derive timing of entering of the mobile object based on the read rule information, the sensing information, and the user skill information.

3. The information processing device according to claim 1, wherein the processor is configured to:
generate, from the sensing information, condition information including conditions of other mobile objects inside and around the intersection;
generate prediction information by predicting a traffic condition of at least one of the other mobile objects in a predetermined period from a present timing based on the condition information; and
derive the entering timing based on the prediction information.

4. The information processing device according to claim 3, further comprising
a memory configured to store intersection information related to the intersection, wherein
the processor is configured to:
read the intersection information from the memory;
generate traveling pattern information by deriving a traveling pattern of when the mobile object enters the intersection based on the read intersection information and the acquired user skill information; and
derive the entering timing based on the traveling pattern information and the prediction information.

5. The information processing device according to claim 3, wherein the processor is configured to derive the condition information based on traveling information of the other mobile objects.

6. The information processing device according to claim 3, wherein the condition information includes information of positions and speeds of the other mobile objects.

7. The information processing device according to claim 1, wherein the processor is configured to derive, as the entering timing, a relative positional relationship between the mobile object and the other mobile objects.

8. The information processing device according to claim 1, wherein the processor is configured to calculate, as the entering timing, remaining time until it becomes possible for the mobile object to enter the intersection.

9. The information processing device according to claim 1, wherein the intersection is a circular intersection.

10. The information processing device according to claim 1, wherein the information communication device is provided in the mobile object.

11. An information processing system comprising:
a first device comprising
a first processor comprising hardware, the first processor being configured to acquire sensing information from a sensor configured to sense other mobile objects inside and around an intersection;
a second device comprising
a second processor comprising hardware, the second processor being configured to acquire user skill information related to driving skill of the user from an information communication device associated with a moving body on which the user rides; and
a third device comprising hardware, the third processor being configured to derive entering timing, at which the mobile object enters the intersection, based on the user skill information acquired by the first device and the sensing information acquired by the second device, and outputting timing information including the entering timing of the mobile object before the mobile object enters the intersection.

12. The information processing system according to claim 11, further comprising
a fourth device comprising
a fourth processor comprising hardware, and
a first memory configured to store rule information related to the intersection, wherein
the fourth processor is configured to read the rule information from the first memory and output the rule information to the third device, and
the third processor is configured to derive timing of entering of the mobile object based on the rule information, the sensing information, and the user skill information.

13. The information processing system according to claim 11, further comprising
a fifth device comprising a fifth processor comprising hardware, the fifth processor being configured to generate, from the sensing information, condition information including conditions of the other mobile objects inside and around the intersection.

14. The information processing system according to claim 13, further comprising
a sixth device comprising a sixth processor comprising hardware, the sixth processor being configured to generate prediction information by predicting a traffic condition of at least one of the other mobile objects in a predetermined period from the present based on the condition information, and
the third processor is configured to derive the entering timing based on the prediction information.

15. The information processing system according to claim 14, further comprising
a seventh device comprising
a seventh processor comprising hardware, and
a second memory configured to store intersection information related to the intersection, wherein
the seventh processor is configured to read the intersection information from the second memory, and generate traveling pattern information by deriving a traveling pattern of when the mobile object enters the intersection based on the intersection information and the user skill information, and
the third processor is configured to derive the entering timing based on the traveling pattern information and the prediction information.

16. The information processing system according to claim 13, wherein the fifth processor is configured to derive the condition information based on traveling information of the other mobile objects.

17. The information processing system according to claim 11, wherein the third processor is configured to derive, as the entering timing, a relative positional relationship between the mobile object and the other mobile objects.

18. The information processing system according to claim 11, wherein the third processor is configured to calculate, as the entering timing, remaining time until it becomes possible for the mobile object to enter the intersection.

19. The information processing system according to claim 11, wherein at least one of the first device and the second device is provided in the mobile object.

20. A non-transitory computer-readable recording medium on which an executable program is recorded, the program instructing a processor to execute:
acquiring user skill information related to driving skill of a use from an information communication device associated with a mobile object on which a user rides,
acquiring sensing information from a sensor configured to sense other mobile objects inside and around an intersection,
deriving entering timing, at which the mobile object enters the intersection, based on the acquired sensing information and the acquired user skill information, and
outputting, to the information communication device, timing information including the entering timing of the mobile object before the mobile unit enters the intersection.
